(19) United States
(12) Patent Application Publication
(10) Pub. No.: US 2025/0340060 A1
(43) Pub. Date: Nov. 6, 2025

(54) INK CONTAINER AND INK EJECTION APPARATUS

(71) Applicant: CANON KABUSHIKI KAISHA, Tokyo (JP)

(72) Inventors: HIROAKI KUSANO, Tokyo (JP); MITSURU CHIDA, Kanagawa (JP); JUNICHIRO IRI, Kanagawa (JP)

(21) Appl. No.: 19/179,136

(22) Filed: Apr. 15, 2025

(30) Foreign Application Priority Data
May 1, 2024 (JP) 2024-074321

(51) Int. Cl. B41J 2/175; B32B 3/08; B32B 15/085; B32B 15/20; B32B 27/32

(52) U.S. Cl. CPC B41J 2/17513; B32B 3/085; B32B 15/085; B32B 15/20; B32B 27/32; B41J 2/17523; B41J 2/17553; B32B 2307/56; B32B 2439/40

(57) ABSTRACT

An ink container for supplying an ink to an ink ejection apparatus that ejects ink includes: an ink storage container configured with a containing space formed for internally containing the ink; and an ink supply port attached to the ink storage container and configured to supply the ink contained in the containing space to the ink ejection apparatus. The ink storage container includes a base layer configured to surround the containing space and a surface layer formed from a plastic material on the outside of the base layer. A first region in which the base layer is exposed and a second region in which the surface layer is exposed are repeatedly formed in a predetermined direction on a surface of the ink storage container.

### BACKGROUND OF THE INVENTION

### Field of the Invention

The present disclosure relates to an ink container and an ink ejection apparatus.

### Description of the Related Art

Liquid ejection apparatuses such as inkjet printers include a carriage that reciprocates across a print medium and a liquid ejection head mounted on the carriage. The liquid ejection head mounted on the carriage ejects liquid such as ink onto the print medium. As a known method for supplying ink to a liquid ejection head, an ink container containing ink is mounted above the liquid ejection head on a carriage, so that the ink is sent from the ink container to the liquid ejection head. Further, as another known method for supplying ink to the liquid ejection head, an ink container is mounted on the main body of a liquid ejection apparatus, so that the ink is sent from the ink container to the liquid ejection head using a pump or the like.

Japanese Patent Laid-Open No. 2013-129101 describes an ink container (liquid container) that has excellent impact resistance against dropping, for example. The ink container described in Japanese Patent Laid-Open No. 2013-129101 is equipped with a cushioning unit for reducing shock if dropped, for example, on the outside of an ink-containing bag capable of containing ink. The cushioning unit is formed by the pressure bonding of two sheets to have convex shapes with air bubbles trapped therein.

In order to reduce the burden on the environment, there is a demand to reduce the amount of plastic material used for ink containers. However, for example, as for an ink container whose ink-containing bag is equipped with a cushioning unit, the cushioning unit is formed using a plastic material, and thus it is difficult to reduce the amount of plastic material used.

### SUMMARY OF THE INVENTION

The ink container according to an embodiment of the present disclosure is an ink container for supplying an ink to an ink ejection apparatus that ejects ink, the ink container including: an ink storage container configured with a containing space formed for internally containing the ink; and an ink supply port attached to the ink storage container and configured to supply the ink contained in the containing space to the ink ejection apparatus. The ink storage container includes a base layer configured to surround the containing space and a surface layer formed from a plastic material on the outside of the base layer. A first region in which the base layer is exposed and a second region in which the surface layer is exposed are repeatedly formed in a predetermined direction on a surface of the ink storage container.

Further features of the present invention will become apparent from the following description of exemplary embodiments with reference to the attached drawings.

### BRIEF DESCRIPTION OF THE DRAWINGS

FIG. 1 is a schematic perspective view of a liquid ejection apparatus;

FIG. 2 is a perspective view of an ink container;

FIG. 3 is a cross-sectional view of the ink container;

FIG. 4 is a cross-sectional view illustrating part of an ink storage container;

FIG. 5 is a perspective view illustrating the surface of the ink container according to the first embodiment;

FIG. 6 is a plan view illustrating the surface of the ink container according to the first embodiment;

FIG. 7 is a flowchart showing a method for manufacturing a sheet member;

FIG. 8 is a perspective view illustrating the surface of an ink container according to the second embodiment;

FIG. 9 is a perspective view illustrating the surface of an ink container according to the third embodiment; and

FIG. 10 is a perspective view illustrating a modification example of the liquid container according to the third embodiment.

### DESCRIPTION OF THE EMBODIMENTS

Hereinafter, a detailed explanation is given of preferable embodiments of the present disclosure with reference to the accompanying drawings. Note that the following embodiments are not intended to limit the contents of the present disclosure, and every combination of the characteristics described in the following embodiments is not necessarily essential to the solutions provided in the present disclosure. Note that the same configurations are assigned with the same signs for their explanations.

### First Embodiment

The technologies described in this specification have the potential to contribute to the achievement of a sustainable society, such as a decarbonized society/circular society. In the present embodiment, an ink container for which the amount of plastic material used is reduced is described as a technology that has the potential to contribute to the achievement of a sustainable society.

### <Configuration of the Liquid Ejection Apparatus>

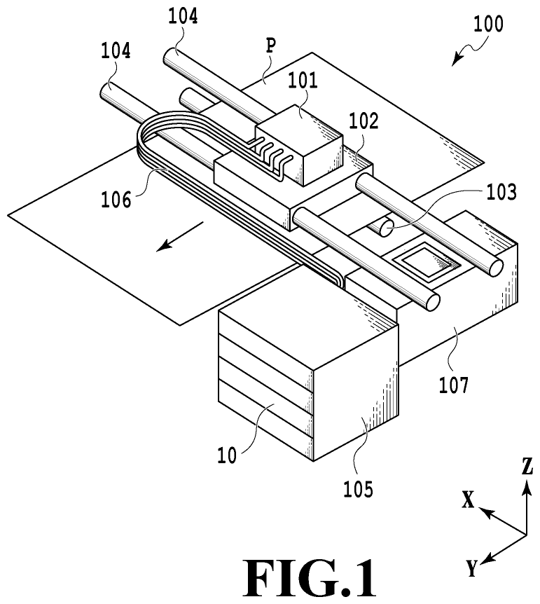

FIG. 1 is a schematic perspective view of the liquid ejection apparatus 100 according to the present embodiment. As illustrated in FIG. 1, the liquid ejection apparatus 100 includes the liquid ejection head 101, the carriage 102, the conveyance roller 103, the liquid supply unit 105, the liquid supply tube 106, and the recovery unit 107. The liquid ejection apparatus 100 repeats reciprocal movement of the liquid ejection head 101 (main scanning) and conveyance of the printing sheet P, which is a print medium, on a per predetermined pitch basis (sub scanning). The liquid ejection apparatus 100 causes the liquid ejection head 101 to selectively eject multiple colors of liquids (e.g., inks, etc.) in synchronization with the above-described main scanning and sub scanning so that the liquids land on the printing sheet P, thereby forming characters, symbols, images, etc. Examples of the liquid ejection apparatus 100 include an inkjet printer, etc. For this reason, the liquid ejection apparatus 100 may be referred to as an ink ejection apparatus, and the liquid ejection head 101 may be referred to as an ink ejection head. Moreover, the liquid supply unit 105 may be referred to as an ink supply unit, and the liquid supply tube 106 may be referred to as an ink supply tube.

Note that the print medium is not limited to the printing sheet P, but may be anything on which an image, etc., can be formed by having ink droplets land on it. For example, print media of various materials and forms such as paper, cloth, an optical disk label, a plastic sheet, an OHP sheet, and an envelope can be used. Further, in each drawing referred to below, the Z direction indicates the vertical direction, which intersects (perpendicularly in the present embodiment) the X-Y plane defined by the X direction and Y direction.

The liquid ejection head 101 is removably mounted on the carriage 102. The carriage 102 is supported by the two guide rails 104 in a free-to-slide manner in the X direction. With a driving unit (not illustrated in the drawings) such as a motor, the carriage 102 on which the liquid ejection head 101 is mounted moves reciprocally in a straight line along the guide rails 104.

The printing sheet P is conveyed by the conveyance roller 103, which is a conveyance unit, in a direction intersecting the moving direction of the carriage 102, specifically, in the direction (Y direction) perpendicular to the moving direction of the carriage 102. The printing sheet P being conveyed by the conveyance roller 103 faces an ink ejection unit (not illustrated in the drawings) of the liquid ejection head 101. The ink ejected from the ink ejection unit of the liquid ejection head 101 lands on the printing sheet P facing the ink ejection unit of the liquid ejection head 101.

The liquid ejection head 101 has multiple nozzle arrays for ejecting different colors of inks, respectively, as a plurality of ink ejection units. A plurality of the independent ink containers 10 is mounted on the liquid supply unit 105 in accordance with the multiple colors of inks ejected from the liquid ejection head 101. Each ink container 10 is removably mounted on the liquid supply unit 105 of the liquid ejection apparatus 100.

The liquid supply unit 105 and the liquid ejection head 101 are connected via a plurality of the liquid supply tubes 106 corresponding to the multiple colors of inks. By mounting the ink containers 10 onto the liquid supply unit 105, the inks of the respective colors contained inside the ink containers 10 can be independently supplied to the respective nozzle arrays of the liquid ejection head 101. In this way, the liquid ejection apparatus 100 has a function of ejecting inks supplied from the ink containers 10.

The recovery unit 107 is installed in a non-printing area within the range of the reciprocal movement of the liquid ejection head 101 and outside the range through which the printing sheet P passes. The recovery unit 107 is placed at a position that faces the ink ejection unit (not illustrated in the drawings) of the liquid ejection head 101 moved to the above-described non-printing area. The recovery unit 107 includes a cap unit, a suction mechanism, a cleaning blade, etc.

The cap unit of the recovery unit 107 is a member for capping the ink ejection unit of the liquid ejection head 101. The suction mechanism of the recovery unit 107 is a mechanism for forcibly suctioning ink in a state where the ink ejection unit of the liquid ejection head 101 is capped. The cleaning blade of the recovery unit 107 is a member for wiping soiling off the ink ejection unit of the liquid ejection head 101. The recovery process by the recovery unit 107, which includes capping with the cap unit and suctioning of ink by the suction mechanism, is performed prior to an ejection operation of the liquid ejection apparatus 100. Even in a case where the liquid ejection apparatus 100 is operated after having been left unused for a long period of time, the recovery process performed by the recovery unit 107 can remove air bubbles remaining in the ink ejection unit of the liquid ejection head 101, ink that has thickened in the vicinity of ejection ports of the liquid ejection head 101, etc. Accordingly, the ejection characteristics of the liquid ejection head 101 are maintained.

### <Configuration of the Ink Containers>

Next, a description is given about the ink container 10 according to the first embodiment. As described above, a plurality of the independent ink containers 10 is mounted on the liquid supply unit (ink supply unit) 105 in accordance with the multiple colors of inks ejected from the liquid ejection head (ink ejection head) 101. Each ink container 10 is removably mounted on the liquid supply unit 105. Each ink container 10 basically has the same configuration.

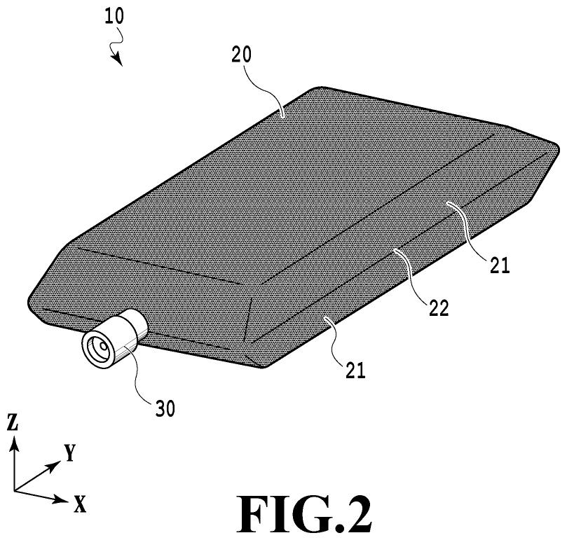

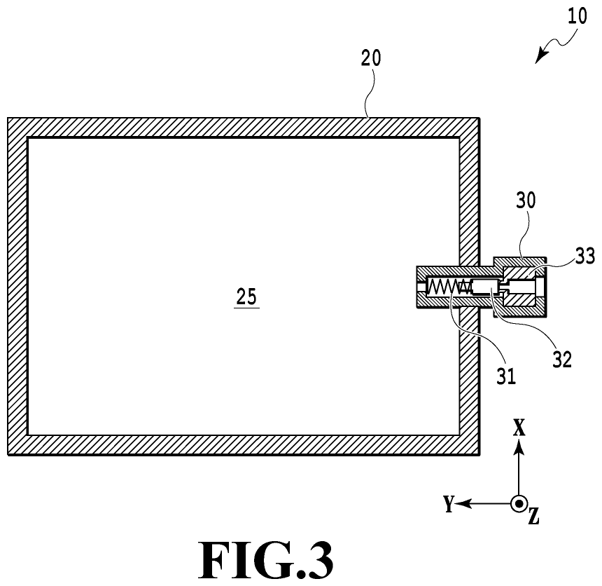

FIG. 2 is a perspective view of the ink container 10 according to the first embodiment. FIG. 3 is a cross-sectional view of the ink container 10 according to the first embodiment. Note that, in FIG. 2 to FIG. 6 and FIG. 8 to FIG. 10, the X direction, Y direction, and Z direction indicate the directions of the ink container 10 being in the state mounted on the liquid supply unit 105. The orientation of the ink container 10 is not limited to the orientation illustrated in FIG. 2 to FIG. 6 and FIG. 8 to FIG. 10, and the orientation of the ink container 10 removed from the liquid supply unit 105 can be changed as appropriate. As illustrated in FIG. 2 and FIG. 3, the ink container 10 includes the ink storage container (ink-containing bag) 20 and the ink supply port 30 for supplying ink (liquid) contained in the ink storage container 20 to the liquid ejection head 101 of the liquid ejection apparatus (ink ejection apparatus) 100.

The ink storage container 20 contains an ink containing a coloring material, which is an example of the liquid to be supplied to the liquid ejection apparatus 100. The ink storage container 20 is formed from the two flexible sheet members 21 into a shape of a so-called pillow-type bag without a gusset. The sheet members 21 are formed in rectangular sheet shapes. The peripheries 22 of the vertically overlapping two sheet members 21 are welded to each other by thermal welding. As a result, the containing space 25 for containing an ink is formed inside the ink storage container 20. Note that the ink storage container 20 is not limited to the above-described pillow type, but may be formed into a shape of a so-called gusseted-type bag with a gusset. In addition, the peripheries 22 of the ink storage container 20 (the sheet members 21) are welded to the periphery of the ink supply port 30 by thermal welding, so that the ink supply port 30 is bonded to an end of the longitudinal direction of the ink storage container 20 (the end in the −Y direction).

The ink supply port 30 is formed in a tubular shape extending in the longitudinal direction of the ink storage container 20 (the Y direction intersecting the Z direction, which is the vertical direction), and is connected to the liquid ejection apparatus 100. At the time the ink container 10 is mounted on the liquid supply unit 105 of the liquid ejection apparatus 100, a nozzle (not illustrated in the drawings) installed in the liquid ejection apparatus 100 is inserted into the ink supply port 30, thereby connecting the ink supply port 30 and the liquid ejection apparatus 100. In the state where the ink supply port 30 and the liquid ejection apparatus 100 are connected, the containing space 25 of the ink storage container 20 and the inside of the liquid supply tube (ink supply tube) 106 are in communication with each other. The spring 31, the valve seat 32, and the seal unit 33 are installed inside the ink supply port 30.

The spring 31 is formed from, for example, a compression coil spring. The spring 31 applies a biasing force that moves the valve seat 32 to the later-described closed position. The valve seat 32 is placed between the spring 31 and the seal unit 33 inside the ink supply port 30. The valve seat 32 is movable along the extending direction of the ink supply port 30 between the closed position where the valve seat 32 closes the opening of the seal unit 33 and the open position where the valve seat 32 is distanced from the seal unit 33. The seal unit 33 is formed in a tubular shape with an opening in its center. In the state where the ink container 10 is removed from the liquid supply unit 105 of the liquid ejection apparatus 100, the valve seat 32 moves to the closed position due to the biasing force of the spring 31 to close the opening of the seal unit 33. The valve seat 32 moves to the closed position due to the biasing force of the spring 31 to close the opening of the seal unit 33, thereby preventing the ink contained in the containing space 25 of the ink storage container 20 from leaking to the outside.

The nozzle (not illustrated in the drawings) installed in the liquid ejection apparatus 100, while inserted into the ink supply port 30, passes through the opening in the seal unit 33 and presses against the valve seat 32. The valve seat 32 pressed by the nozzle of the liquid ejection apparatus 100 moves from the closed position to the open position against the biasing force of the spring 31, thereby forming a gap between the valve seat 32 and the seal unit 33. As a result, inside the ink supply port 30 connected to the liquid ejection apparatus 100, a path is formed for supplying the ink from the containing space 25 of the ink storage container 20 to the liquid ejection apparatus 100 via the nozzle. In this way, in the state where the ink container 10 is mounted on the liquid supply unit 105 of the liquid ejection apparatus 100, the nozzle installed in the liquid ejection apparatus 100 causes the valve seat 32 to move against the biasing force of the spring 31 to the open position. Once the valve seat 32 has moved to the open position, it is possible to supply the ink (liquid) contained in the containing space 25 to the liquid ejection head 101 of the liquid ejection apparatus 100 via the ink supply port 30. Note that the gap between the nozzle of the liquid ejection apparatus 100 and the ink supply port 30 is sealed with the seal unit 33.

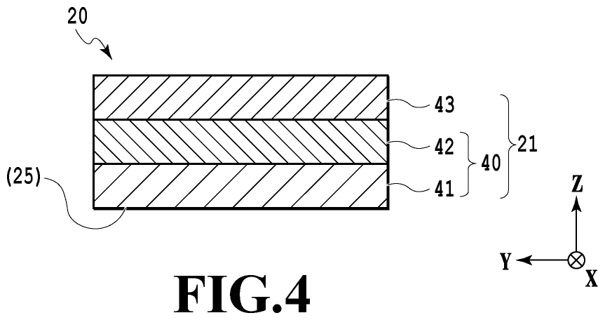

FIG. 4 is a cross-sectional view illustrating part of the ink storage container 20. As illustrated in FIG. 4, the sheet member 21 of the ink storage container 20 has the base layer 40 that surrounds the containing space 25 and the surface layer 43 formed on the outside of the base layer 40. Further, the base layer 40 includes the inner layer 41 and the barrier layer 42.

The inner layer 41 is formed from a plastic material on the inside of the ink storage container 20, so as to surround the containing space 25. As the plastic material for the inner layer 41, polyethylene (PE) may be used, for example. The peripheries 22 of the two sheet members 21 are welded to each other at the inner layers 41 by thermal welding. Further, the peripheries 22 of the two sheet members 21 are welded to the outer periphery of the ink supply port 30 at the inner layers 41. The inner layers 41 are also referred to as welding layers.

The barrier layer 42 is formed from a metal material on the outside of the inner layer 41. As the metal material for the barrier layer 42, aluminum (Al) may be used, for example. The barrier layer 42 suppresses liquid and gas from passing through the sheet member 21. This makes it possible to suppress events that cause deterioration of the ink, such as a decrease in the amount of solvent included in the ink contained in the containing space 25 (an increase in the viscosity of the ink) and an inflow of air from outside the ink storage container 20 into the containing space 25.

The surface layer 43 is formed from a plastic material on the outside of the barrier layer 42. As the plastic material for the surface layer 43, polyethylene or polyamide (PA) may be used, for example. The surface layer 43 is an impact reducing layer for reducing the impact that the ink storage container 20 receives if dropped, for example.

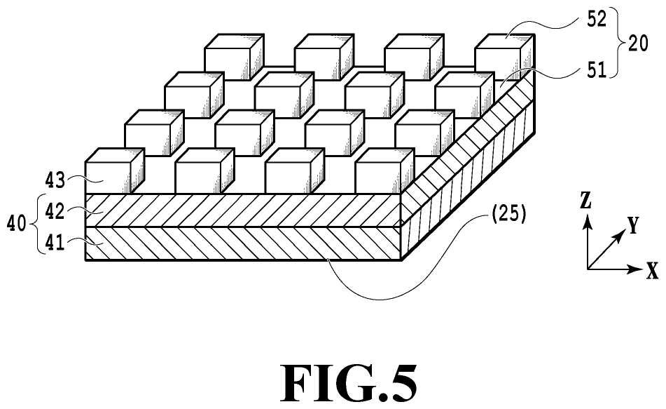

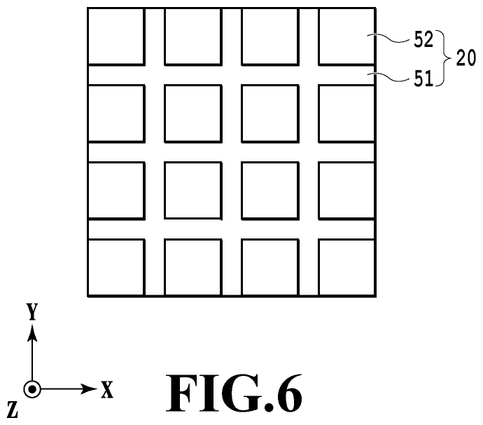

FIG. 5 is a perspective view illustrating the surface of the ink storage container 20 in the ink container 10 according to the first embodiment. FIG. 6 is a plan view illustrating the surface of the ink storage container 20 in the ink container 10 according to the first embodiment. As illustrated in FIG. 5 and FIG. 6, the surface layer 43 is formed into rectangular parallelepiped shapes aligned side by side in the X and Y directions on the surface of the ink storage container 20. As a result, the first region 51 in which the base layer 40 (the barrier layer 42) is exposed and the second region 52 in which the surface layer 43 is exposed are repeatedly formed in predetermined directions (the X direction and Y direction) on the surface of the ink storage container 20. Note that the second region 52 is formed in quadrangular shapes (for example, square shapes) in a plan view. The first region 51 is formed in frame shapes surrounding the second region 52 in a plan view. Further, the first region 51 and the second region 52 may be formed in a periodically repeated manner in a predetermined direction, or may be formed in a non-periodically repeated manner in a predetermined direction.

The first region 51 includes two layers (the inner layer 41 and the barrier layer 42), and the barrier layer 42 on the outside is exposed. The second region 52 includes three layers (the inner layer 41, the barrier layer 42, and the surface layer 43), and the outermost surface layer 43 is exposed. The thickness of the first region 51 is, for example, 30 μm to 80 μm. The thickness of the second region 52 is greater than the thickness of the first region 51 and is, for example, 50 μm to 150 μm. If the difference in thickness between the first region 51 and the second region 52 is large, the surface layer 43 is thick, and thus the impact that the ink storage container 20 receives if dropped, for example, can be significantly reduced. On the other hand, if the difference in thickness between the first region 51 and the second region 52 is small, the surface layer 43 is thin, and thus the ink storage container 20 can be easily deformed, making it easier to use up the ink contained in the containing space 25 of the ink storage container 20.

Further, the length of the surface layer 43 in the second region 52 in the X or Y direction is, for example, 1 mm to 10 mm. The interval between the surface layers 43 in the second region 52 in the X direction or Y direction is, for example, 0.5 mm to 10 mm.

The area of the second region 52 may be larger than the area of the first region 51. In this case, the ratio of the area of the second region 52 to the sum of the area of the first region 51 and the area of the second region 52 is preferably 0.6 to 0.9 (60% to 90%). Accordingly, the area of the second region 52 with the surface layer 43 exposed is large, and thus the amount of plastic material used for the ink container 10 can be reduced while significantly reducing the impact that the ink storage container 20 receives if dropped, for example. Note that the sum of the area of the first region 51 and the area of the second region 52 may be the area of the entire surface of the ink storage container 20.

Further, the area of the second region 52 may be smaller than the area of the first region 51. In this case, the ratio of the area of the second region 52 to the sum of the area of the first region 51 and the area of the second region 52 is preferably 0.1 to 0.4 (10% to 40%). Accordingly, the area of the second region 52 with the surface layer 43 exposed is small, and thus, while reducing the impact that the ink storage container 20 receives if dropped, for example, the amount of plastic material used for the ink container 10 can be significantly reduced. Further, the ink storage container 20 can be easily deformed, making it easier to use up the ink contained in the containing space 25 of the ink storage container 20. Note that the sum of the area of the first region 51 and the area of the second region 52 may be the area of the entire surface of the ink storage container 20.

In the present embodiment, the first region 51 in which the base layer 40 (the barrier layer 42) is exposed and the second region 52 in which the surface layer 43 is exposed are repeatedly formed in predetermined directions (the X direction and Y direction) on the surface of the ink storage container 20. By forming the first region 51 which does not include the surface layer 43 as part of the surface of the ink storage container 20, the area of the second region 52 which includes the surface layer 43 is limited to the minimum necessary size. Accordingly, while the impact that the ink storage container 20 receives if dropped, for example, can be reduced by the surface layer 43 of the second region 52, the amount of plastic material used for the ink container 10 can be reduced.

### <Method for Manufacturing the Sheet Members>

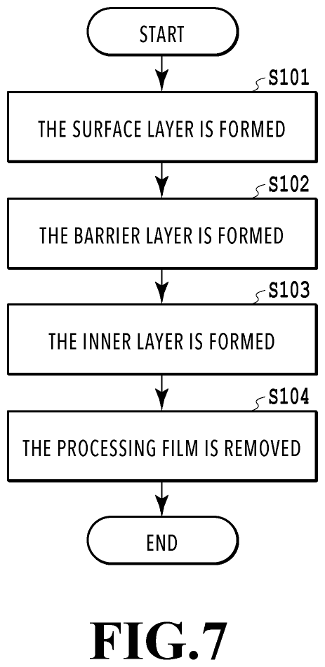

Next, a method for manufacturing the sheet member 21 constituting the ink storage container 20 is described with reference to FIG. 7. FIG. 7 is a flowchart showing a method for manufacturing the sheet member 21.

First, in step S101, the surface layer 43 of the sheet member 21 is formed on a processing film (not illustrated in the drawings) which has an adhesive surface. At this time, a surface layer film (not illustrated in the drawings) for forming the surface layer 43 is attached to the adhesive surface of the processing film. Then, unnecessary portions of the surface layer film are removed so as to form the surface layer 43 with the rectangular parallelepiped shapes aligned in the X and Y directions. For example, it is possible to remove the unnecessary portions of the surface layer film by a cutting process (removing process) using a cutting tool, a removing process using laser light, or the like. Further, an adhesive is applied to the adhesive surface of the processing film. As the adhesive, for example, an acrylic adhesive made of an acrylic polymer, a urethane adhesive made of polyurethane, a silicone adhesive containing a silicone polymer as a main component, or the like can be used.

In the next step S102, the barrier layer 42 of the sheet member 21 is formed on the inside of the surface layer 43. At this time, an adhesive is uniformly applied to the surface of the surface layer film (the surface layer 43) on the opposite side of the processing film, and a barrier layer film (not illustrated in the drawings) for forming the barrier layer 42 is attached thereto. Then, the surface layer film (the surface layer 43) and the barrier layer film (the barrier layer 42) are pressurized and heated to cure the adhesive.

In the next step S103, the inner layer 41 of the sheet member 21 is formed on the inner side of the barrier layer 42. At this time, an adhesive is uniformly applied to the surface of the barrier layer film (the barrier layer 42) on the opposite side of the surface layer film (the surface layer 43), and an inner layer film (not illustrated in the drawings) for forming the inner layer 41 is attached thereto. Then, the barrier layer film (the barrier layer 42) and the inner layer film (the inner layer 41) are pressurized and heated to cure the adhesive.

Then, in step S104, the processing film is peeled off and removed from the surface layer film (the surface layer 43). In this way, the sheet member 21 in which the inner layer 41, the barrier layer 42, and the surface layer 43 are laminated is manufactured.

As described above, the ink storage container 20 is formed from the two sheet members 21 into the shape of a bag with the containing space 25 formed therein.

As described above, according to the first embodiment, it is possible to provide the ink container 10 for which a reduced amount of plastic material is used. That is, in the present embodiment, the first region 51 in which the base layer 40 (the barrier layer 42) is exposed and the second region 52 in which the surface layer 43 is exposed are repeatedly formed in a predetermined direction on the surface of the ink storage container 20. By forming the first region 51 which does not include the surface layer 43 as part of the surface of the ink storage container 20, the area of the second region 52 which includes the surface layer 43 is limited to the minimum necessary size. Accordingly, while the impact that the ink storage container 20 receives if dropped, for example, can be reduced by the surface layer 43 of the second region 52, the amount of plastic material used for the ink container 10 can be reduced. In this way, it is possible to provide the ink container 10 for which a reduced amount of plastic material is used.

The area of the second region 52 may be larger than the area of the first region 51. Accordingly, the area of the second region 52 with the surface layer 43 exposed is large, and thus the amount of plastic material used for the ink container 10 can be reduced while significantly reducing the impact that the ink storage container 20 receives if dropped, for example.

Further, the area of the second region 52 may be smaller than the area of the first region 51. Accordingly, the area of the second region 52 with the surface layer 43 exposed is small, and thus, while reducing the impact that the ink storage container 20 receives if dropped, for example, the amount of plastic material used for the ink container 10 can be significantly reduced. Further, the ink storage container 20 can be easily deformed, making it easier to use up the ink contained in the containing space 25 of the ink storage container 20.

Further, the second region 52 is formed in quadrangular shapes (for example, square shapes) in a plan view, and the first region 51 is formed in frame shapes surrounding the second region 52 in a plan view. This simplifies the surface shape of the ink storage container 20, making it possible to easily form the first region 51 and the second region 52.

Further, the base layer 40 includes the inner layer 41 and the barrier layer 42, and aluminum (Al) is used as the metal material for the barrier layer 42. This makes it possible to suppress events that cause deterioration of the ink, such as a decrease in the amount of solvent included in the ink contained in the containing space 25 (an increase in the viscosity of the ink) and an inflow of air from outside the ink storage container 20 into the containing space 25.

Further, the base layer 40 includes the inner layer 41 and the barrier layer 42, and polyethylene (PE) is used as the plastic material for the inner layer 41. Therefore, the ink storage container 20 can be easily formed into a bag shape by welding the peripheries 22 of the two sheet members 21 to each other by thermal welding at the inner layers 41.

In the above-described first embodiment, the surface layer 43 is formed in the rectangular parallelepiped shapes of the same size over the entire surface of the ink storage container 20, but there is no such limitation. For example, the surface layer 43 may be formed in rectangular parallelepiped shapes with different sizes depending on the position on the surface of the ink storage container 20. Further, the surface layer is not limited to rectangular parallelepiped shapes, and may be formed in quadrangular pyramid shapes or triangular pyramid shapes. The surface layer may be formed in hemispherical shapes, conical shapes, or cylindrical shapes.

### Second Embodiment

Next, a description is given about the second embodiment. Since each of the members in the second embodiment has the same configuration as in the above-described first embodiment, the description is given with the same signs as those in the above-described first embodiment. The ink container 10 according to the second embodiment is formed in the same manner as the ink container 10 according to the first embodiment, except for the shapes of the surface layer 43.

### <Configuration of the Ink Containers>

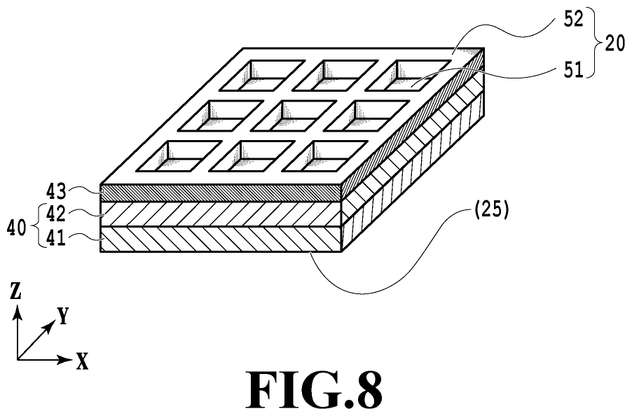

FIG. 8 is a perspective view illustrating the surface of the ink storage container 20 in the ink container 10 according to the second embodiment. As illustrated in FIG. 8, the surface layer 43 is formed into rectangular tubular shapes aligned side by side in the X and Y directions on the surface of the ink storage container 20. As a result, the first region 51 in which the base layer 40 (the barrier layer 42) is exposed and the second region 52 in which the surface layer 43 is exposed are repeatedly formed in predetermined directions (the X direction and Y direction) on the surface of the ink storage container 20. Note that the first region 51 is formed in quadrangular shapes (for example, square shapes) in a plan view. The second region 52 is formed in frame shapes surrounding the first region 51 in a plan view. Further, the first region 51 and the second region 52 may be formed in a periodically repeated manner in a predetermined direction, or may be formed in a non-periodically repeated manner in a predetermined direction.

As in the first embodiment, the first region 51 includes two layers (the inner layer 41 and the barrier layer 42), and the barrier layer 42 on the outside is exposed. The second region 52 includes three layers (the inner layer 41, the barrier layer 42, and the surface layer 43), and the outermost surface layer 43 is exposed. The thickness of the first region 51 is similar to the thickness of the first region 51 according to the first embodiment. The thickness of the second region 52 is similar to the thickness of the second region 52 according to the first embodiment.

As in the first embodiment, the area of the second region 52 may be larger than the area of the first region 51. In this case, the ratio of the area of the second region 52 to the sum of the area of the first region 51 and the area of the second region 52 is preferably 0.6 to 0.9 (60% to 90%). Further, the area of the second region 52 may be smaller than the area of the first region 51. In this case, the ratio of the area of the second region 52 to the sum of the area of the first region 51 and the area of the second region 52 is preferably 0.1 to 0.4 (10% to 40%).

In the present embodiment, the first region 51 in which the base layer 40 (the barrier layer 42) is exposed and the second region 52 in which the surface layer 43 is exposed are repeatedly formed in predetermined directions (the X direction and Y direction) on the surface of the ink storage container 20. By forming the first region 51 which does not include the surface layer 43 as part of the surface of the ink storage container 20, the area of the second region 52 which includes the surface layer 43 is limited to the minimum necessary size. Accordingly, while the impact that the ink storage container 20 receives if dropped, for example, can be reduced by the surface layer 43 of the second region 52, the amount of plastic material used for the ink container 10 can be reduced.

Note that the sheet members 21 constituting the ink storage container 20 are manufactured using the similar manufacturing method as in the first embodiment. Therefore, a description of the manufacturing method for the sheet members 21 is omitted.

As described above, according to the second embodiment, as with the first embodiment, it is possible to provide the ink container 10 for which a reduced amount of plastic material is used.

Further, in the second embodiment, the first region 51 is formed in quadrangular shapes (for example, square shapes) in a plan view, and the second region 52 is formed in frame shapes surrounding the first region 51 in a plan view. This simplifies the surface shape of the ink storage container 20, making it possible to easily form the first region 51 and the second region 52.

In the above-described second embodiment, the surface layer 43 is formed in the quadrangular tubular shapes of the same size over the entire surface of the ink storage container 20, but there is no such limitation. For example, the surface layer 43 may be formed in quadrangular tubular shapes with different sizes depending on the position on the surface of the ink storage container 20. Further, the surface layer is not limited to the quadrangular tubular shapes, but may be formed in hexagonal tubular shapes (honeycomb shapes) or triangular tubular shapes.

### Third Embodiment

Next, a description is given about the third embodiment. Since each of the members in the third embodiment has the same configuration as in the above-described first embodiment, the description is given with the same signs as those in the above-described first embodiment. The ink container 10 according to the third embodiment is formed in the same manner as the ink container 10 according to the first embodiment, except for the shapes of the surface layer 43.

### <Configuration of the Ink Containers>

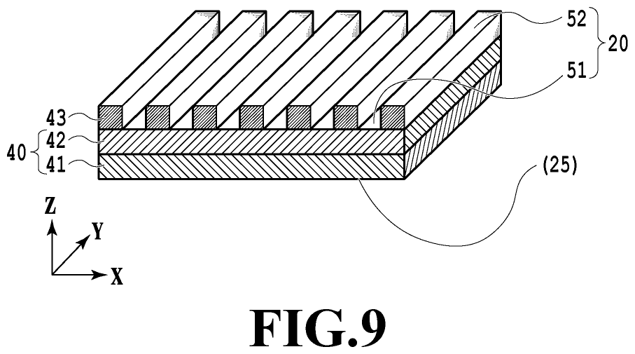

FIG. 9 is a perspective view illustrating the surface of the ink storage container 20 in the ink container 10 according to the third embodiment. As illustrated in FIG. 9, the surface layer 43 is formed into rectangular parallelepiped shapes elongated in the Y direction and aligned side by side in the X direction on the surface of the ink storage container 20. As a result, the first region 51 in which the base layer 40 (the barrier layer 42) is exposed and the second region 52 in which the surface layer 43 is exposed are repeatedly formed in a predetermined direction (the X direction) on the surface of the ink storage container 20. Note that the first region 51 is formed so as to extend linearly in the Y direction in a plan view. The second region 52 is formed adjacent to the first region 51 in a plan view so as to extend linearly in the Y direction. Further, the first region 51 and the second region 52 may be formed in a periodically repeated manner in a predetermined direction, or may be formed in a non-periodically repeated manner in a predetermined direction.

As in the first embodiment, the first region 51 includes two layers (the inner layer 41 and the barrier layer 42), and the barrier layer 42 on the outside is exposed. The second region 52 includes three layers (the inner layer 41, the barrier layer 42, and the surface layer 43), and the outermost surface layer 43 is exposed. The thickness of the first region 51 is similar to the thickness of the first region 51 according to the first embodiment. The thickness of the second region 52 is similar to the thickness of the second region 52 according to the first embodiment.

As in the first embodiment, the area of the second region 52 may be larger than the area of the first region 51. In this case, the ratio of the area of the second region 52 to the sum of the area of the first region 51 and the area of the second region 52 is preferably 0.6 to 0.9 (60% to 90%). Further, the area of the second region 52 may be smaller than the area of the first region 51. In this case, the ratio of the area of the second region 52 to the sum of the area of the first region 51 and the area of the second region 52 is preferably 0.1 to 0.4 (10% to 40%).

In the present embodiment, the first region 51 in which the base layer 40 (the barrier layer 42) is exposed and the second region 52 in which the surface layer 43 is exposed are repeatedly formed in a predetermined direction (the X direction) on the surface of the ink storage container 20. By forming the first region 51 which does not include the surface layer 43 as part of the surface of the ink storage container 20, the area of the second region 52 which includes the surface layer 43 is limited to the minimum necessary size. Accordingly, while the impact that the ink storage container 20 receives if dropped, for example, can be reduced by the surface layer 43 of the second region 52, the amount of plastic material used for the ink container 10 can be reduced.

Note that the sheet members 21 constituting the ink storage container 20 are manufactured using the similar manufacturing method as in the first embodiment. Therefore, a description of the manufacturing method for the sheet members 21 is omitted.

As described above, according to the third embodiment, as with the first embodiment, it is possible to provide the ink container 10 for which a reduced amount of plastic material is used.

Further, in the third embodiment, the first region 51 is formed so as to extend linearly in a plan view, and the second region 52 is formed adjacent to the first region 51 so as to extend linearly in a plan view. This simplifies the surface shape of the ink storage container 20, making it possible to easily form the first region 51 and the second region 52.

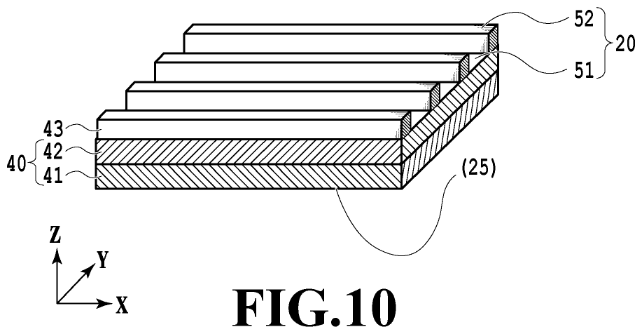

In the above-described third embodiment, the first region 51 and the second region 52 are repeatedly formed in the X direction on the surface of the ink storage container 20, but there is no such limitation. FIG. 10 is a perspective view illustrating a modification example of the ink container 10 according to the third embodiment. As illustrated in FIG. 10, the surface layer 43 may be formed into rectangular parallelepiped shapes elongated in the X direction and aligned side by side in the Y direction on the surface of the ink storage container 20. Therefore, the first region 51 and the second region 52 may be repeatedly formed in the Y direction on the surface of the ink storage container 20. In this case, the first region 51 may be formed so as to extend linearly in the X direction in a plane view. The second region 52 may be formed adjacent to the first region 51 in a plan view so as to extend linearly in the X direction. In this way, as with the first embodiment, it is possible to provide the ink container 10 for which a reduced amount of plastic material is used.

In each of the above-described embodiments, the first region 51 and the second region 52 are formed in the same shapes over the entire surface of the ink storage container 20, but there is no such limitation. The first region 51 and the second region 52 according to the first embodiment may be formed repeatedly in a predetermined direction as part of the surface of the ink storage container 20, and the first region 51 and the second region 52 according to the second embodiment may be formed repeatedly in a predetermined direction as the remaining portion of the surface excluding that part. The first region 51 and the second region 52 according to the first embodiment may be formed repeatedly in a predetermined direction as part of the surface of the ink storage container 20, and the first region 51 and the second region 52 according to the third embodiment may be formed repeatedly in a predetermined direction as the remaining portion of the surface excluding that part. The first region 51 and the second region 52 according to the second embodiment may be formed repeatedly in a predetermined direction as part of the surface of the ink storage container 20, and the first region 51 and the second region 52 according to the third embodiment may be formed repeatedly in a predetermined direction as the remaining portion of the surface excluding that part. Further, the surface of the ink storage container 20 may be formed with a mixture of the first region 51 and the second region 52 according to the first embodiment, the first region 51 and the second region 52 according to the second embodiment, and the first region 51 and the second region 52 according to the third embodiment.

In each of the above-described embodiments, the surface layer 43 is configured with one layer, but there is no such limitation. For example, the surface layer may be configured with two layers, or may be configured with three or more layers.

In each of the above-described embodiments, the base layer 40 is configured with two layers (the inner layer 41 and the barrier layer 42), but there is no such limitation. For example, the base layer may be configured with one layer, or may be configured with three or more layers.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-074321, filed May 1, 2024, which is hereby incorporated by reference wherein in its entirety.

What is claimed is:

1. An ink container for supplying an ink to an ink ejection apparatus that ejects ink, the ink container comprising:
an ink storage container configured with a containing space formed for internally containing the ink; and
an ink supply port attached to the ink storage container and configured to supply the ink contained in the containing space to the ink ejection apparatus,
wherein the ink storage container includes
a base layer configured to surround the containing space and
a surface layer formed from a plastic material on the outside of the base layer, and
wherein a first region in which the base layer is exposed and a second region in which the surface layer is exposed are repeatedly formed in a predetermined direction on a surface of the ink storage container.

2. The ink container according to claim 1,
wherein the area of the second region is larger than the area of the first region.

3. The ink container according to claim 2,
wherein the ratio of the area of the second region to the sum of the area of the first region and the area of the second region is 0.6 to 0.9.

4. The ink container according to claim 1,
wherein the area of the second region is smaller than the area of the first region.

5. The ink container according to claim 4,
wherein the ratio of the area of the second region to the sum of the area of the first region and the area of the second region is 0.1 to 0.4.

6. The ink container according to claim 1,
wherein the plastic material for the surface layer is polyethylene or polyamide.

7. The ink container according to claim 1,
wherein the surface layer is an impact reducing layer for reducing an impact that the ink storage container receives.

8. The ink container according to claim 1,
wherein the base layer includes
an inner layer formed from a plastic material to surround the containing space and
a barrier layer formed from a metal material on the outside of the inner layer, and
wherein the surface layer is formed on the outside of the barrier layer.

9. The ink container according to claim 8,
wherein the metal material for the barrier layer is aluminum.

10. The ink container according to claim 8,
wherein the plastic material for the inner layer is polyethylene.

11. The ink container according to claim 1,
wherein the ink container is removably mounted on the ink ejection apparatus,
wherein the ink supply port includes
a valve seat attached to the inside of the ink supply port and configured to be movable between an open position, where the ink contained in the containing space can be supplied to the ink ejection apparatus via the ink supply port, and a closed position, where the ink contained in the containing space is blocked from leaking to the outside, and
a spring configured to apply a biasing force to move the valve seat to the closed position,
wherein, in a state where the ink container is mounted on the ink ejection apparatus, the valve seat moves to the open position against the biasing force of the spring, and
wherein, in a state where the ink container is removed from the ink ejection apparatus, the valve seat moves to the closed position due to the biasing force of the spring.

12. The ink container according to claim 1,
wherein the second region is formed in a quadrangular shape in a plan view, and
wherein the first region is formed in a frame shape surrounding the second region in a plan view.

13. The ink container according to claim 1,
wherein the first region is formed in a quadrangular shape in a plan view, and
wherein the second region is formed in a frame shape surrounding the first region in a plan view.

14. The ink container according to claim 1,
wherein the first region is formed so as to extend linearly in a plan view, and
wherein the second region is formed adjacent to the first region so as to extend linearly in a plan view.

15. An ink ejection apparatus comprising:
an ink ejection head configured to eject ink; and
an ink container configured to supply an ink to the ink ejection head,
wherein the ink container includes
an ink storage container configured with a containing space formed for internally containing the ink and
an ink supply port attached to the ink storage container and configured to supply the ink contained in the containing space to the ink ejection head,
wherein the ink storage container includes
a base layer configured to surround the containing space and
a surface layer formed from a plastic material on the outside of the base layer, and
wherein a first region in which the base layer is exposed and a second region in which the surface layer is exposed are repeatedly formed in a predetermined direction on a surface of the ink storage container.
